(19) United States
(12) Patent Application Publication
(10) Pub. No.: US 2005/0209865 A1
(43) Pub. Date: Sep. 22, 2005

(54) Architecture to integrate different software subsystems

(76) Inventors: Aravind Doss, Hillsboro, OR (US); Mingqiu Sun, Beaverton, OR (US); Ravindra Sharma, Portland, OR (US); Michael P. Herring, Beaverton, OR (US); Chandramouli Padmanaban, Portland, OR (US); Michael J. Scott, Hillsboro, OR (US); Shannon L. Nelson, Portland, OR (US)

Correspondence Address: TROP PRUNER & HU, PC, 8554 KATY FREEWAY, SUITE 100, HOUSTON, TX, 77024, US

(21) Appl. No.: 10/802,510

(22) Filed: Mar. 17, 2004

(51) Int. Cl. G06F 17/60

(52) U.S. Cl. 705/1

(57) ABSTRACT

A technique includes providing a first request to access a function that is associated with a first object model. The first request is converted into a second request that is associated with a second object model that is different from the first object model. The technique includes creating an object that is associated with the second object model in response to the second request.

### BACKGROUND

The invention generally relates to an architecture to integrate different software subsystems, such as those in a computing environment.

A computing environment typically has many different software subsystems that reside on various networked computers for purposes of controlling different steps of a computing process. For example, a computing facility to fabricate integrated circuits may include one or more software subsystems to handle materials, control execution of the fabrication, etc.

The software subsystems typically are provided by different software vendors. Thus, the software subsystems typically present different software structures, communication protocols, messaging schemes, etc. There are occasions in which it may be desirable for the software subsystems to communicate with each other. However, implementing this communication may present challenges, as some of the communication protocols and software architectures may be incompatible with each other. As a result, a significant amount of time and resources may be spent resolving the various incompatibility problems that arise when attempting to integrate these software subsystems.

Therefore, there is a continuing need for a technique that addresses one or more of the problems stated above as well as possibly addresses one or more problems that are not set forth above.

### BRIEF DESCRIPTION OF THE DRAWINGS

FIG. 1 is a schematic diagram of a computing system according to an embodiment of the invention.

FIG. 2 is a schematic diagram of a software architecture of the system of FIG. 1 for communicating service and data requests among different software subsystems according to an embodiment of the invention.

FIG. 3 is a flow diagram depicting a technique to initialize the architecture depicted in FIG. 2 according to an embodiment of the invention.

FIG. 4 is a schematic diagram of a selected portion of the architecture of FIG. 2 depicting the initialization of the software architecture according to an embodiment of the invention.

FIG. 5 is a flow diagram depicting a technique to discover a service of the architecture of FIG. 2 according to an embodiment of the invention.

FIG. 6 is a schematic diagram of a selected portion of the architecture of FIG. 2 depicting the discovery of a service by a client according to an embodiment of the invention.

FIGS. 7 and 9 are flow diagrams depicting techniques used to process requests from clients according to an embodiment of the invention.

FIGS. 8 and 10 are schematic diagrams of selected portions of the software architecture illustrating processing of client requests according to an embodiment of the invention.

FIG. 11 is a schematic diagram of a software architecture according to another embodiment of the invention.

### DETAILED DESCRIPTION

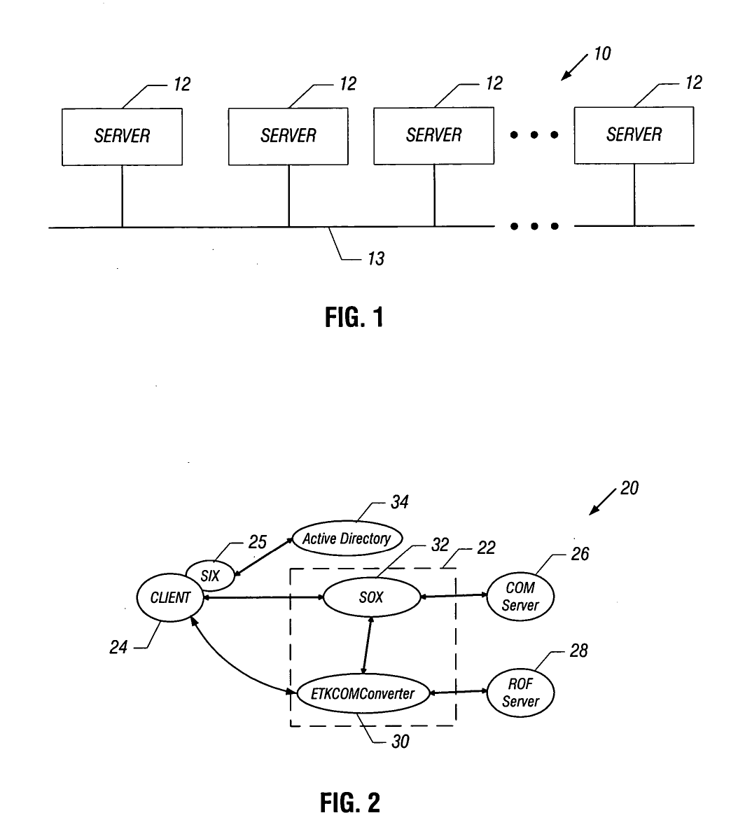

Referring to FIG. 1, an embodiment 10 of a computing system in accordance with the invention includes various physical computer servers 12 that form a hardware backbone for executing software to control a computing environment. In some embodiments of the invention, the servers 12 may be executing software packages that are provided by different vendors for purposes of controlling various computing processes related to the fabrication of semiconductor devices. For example, these computing processes may include fabrication execution processes, material handling processes, etc.

As a more specific example, in some embodiments of the invention, each server 12 may be a stand-alone computer unit that is coupled to the other servers 12 via a local area network (LAN) 13. In some embodiments of the invention, each of the servers 12 may be executing a Windows® operating system (a Windows 2000® operating system, for example). The servers 12 may form a distributed software architecture in that more than one server 12 may execute software that is associated with a particular software subsystem.

In some embodiments of the invention, the servers may be executing software packages that are provided by different vendors for purposes of facilitating business process implementation (execution, tracking, configuration, data collection, etc).

The software that is executed by the servers may be supplied by several different software vendors and operate pursuant to different communication protocols, message formats and object models.

This invention provides a mechanism that allows integration of the above disparate software into a consistent, unified object model which can be exposed to any of the protocols supported. The unification of the disparate object models is executed through scripting of the protocol, message format and object translations in a COM environment.

The desired object model is exposed via creation of an object called a Scripting Object Cross Connect(SOX), which implements the message format and object translations. The SOX leverages framework provided protocol converters, such as the ETKCOMConverter developed to support this invention.

For example, in some embodiments of the invention, a particular application on one of the servers 12 may execute a Component Object Model (COM) application that uses calls to various COM objects. In accordance with the COM protocol, the application may access different interfaces of possibly several different COM objects. Each interface is associated with a different method or function to be performed. For example, a particular interface may be associated with performing a certain mathematical function.

To access a particular interface, the COM application creates an instance of a COM object by call a create instance function and specifying the COM class that is associated with the interface and the identity of the interface. After an instance of the COM object is created, the instance of the COM object supplies a pointer, or handle, that the invoking application uses to access the desired interface of the COM object.

For purposes of simplifying the design of the system 10, various COM objects may be located on one or more of the servers 12 so that a particular object may be accessed by more than one application. Thus, ideally, to perform a particular function, the program code to implement the associated COM interface is written and stored in a registered location in the system 10. Thus, regardless of the number of applications that desire a particular function, an instance of the COM object containing this interface may be created.

However, not all of the application code that is written for the system 10 follows the same object model, and thus, not all of the software is designed to create and use instances of COM objects. In this manner, some of the applications that execute on the computing system 10 may use a different object model. Therefore, in conventional computing systems, applications that use a second object model (i.e., an object model other than a COM object model, for example) may not benefit from program code written to implement functions pursuant to a first object model (such as COM, for example) and vice versa.

However, unlike conventional architectures, in accordance with an embodiment of the invention, the computing system 10 includes a software architecture 20 (depicted in FIG. 2) that integrates software that uses different object models and/or different communication protocols. In some embodiments of the invention, the software architecture 20 forms a virtual request/reply server that may physically reside on multiple servers 12 of the computing system 10.

Referring to FIG. 2, in some embodiments of the invention, the architecture 20 includes a scripting object cross-connect (SOX) object 32 that provides an interface that may be accessed (as set forth below) by either clients 24 (i.e., the application requesting the particular service or data) that operate in accordance with a first object model or clients 24 that operate pursuant to a different object model. By way of example, the architecture 20 is discussed herein for the case where the first object model is a Component Object Model (COM), and the second object model is a model pursuant to a Remote Object Framework (ROF), a framework established by Tibco of Palo Alto, Calif., and which may be used in connection with TIBCO's enterprise tool kit, available from Tibco.

The ROF establishes information objects and service objects. Information objects contain data that is passed between applications, and service objects are applications that implement operations that may be invoked by other applications. Objects associated with the ROF object model are stored on an ROF server 28, of the architecture 20 and objects that are associated with the COM object model are stored on a COM server 26 of the architecture 20. Each COM server 26 and each ROF 28 server may be located on one or more physical servers 12 (FIG. 1).

In some embodiments of the invention, the SOX component 32 may be accessed by either clients 24 (i.e., the application requesting the particular service or data) that operate in accordance with a first object model or clients 24 that operate pursuant to a different object model. The SOX component 32 provides interfaces that may be accessed by either ROF or COM clients, as described below. More specifically, in some embodiments of the invention, when a COM client 24 needs to invoke an instance of an object for purposes of performing a particular function, the software architecture 20 establishes an appropriate instance of the SOX component 32. The instance of the SOX component 32, in turn, retrieves appropriate scripts to perform the function desired by the client 24.

It is noted that SOX instance 32 is not limited to invoking COM objects to respond to requests from COM clients and invoking ROF objects to respond to requests from ROF clients. Rather, the script that is executed by the SOX instance 32 governs whether COM objects or ROF objects are executed to perform the desired function. Therefore, regardless if a particular function was written pursuant to a COM object model or an ROF object model, the SOX instance 32 selects the appropriate object to perform the desired function.

Pursuant to the COM and ROF object models, different techniques are used to discover the various available functions. However, the architecture 20 accommodates the different discovery techniques. For example, in some embodiments of the invention, the architecture 20 includes a scripted interface cross-connect (SIX) component 25 that provides interface discovery services to COM clients so that COM clients may locate remote objects through the use of an active directory 34. As a more specific example, the active directory 34 may be a 2000® Active Directory, in some embodiments of the invention. Due the SIX component 25, the COM client 24 does not need to know the physical location of the particular servers from which objects are sought, and load balancing may be achieved as servers can be distributed on multiple physical computing machines.

The ROF client uses a messaging scheme to discover available functions. To accommodate this scheme, the architecture 20 cooperates with a publish-scribe architecture (described below) that permits COM and ROF objects to communicate. Thus, through this communication, the ROF client may locate the desired function.

In some embodiments of the invention, the SOX component 32 is designed to communicate directly with COM objects and not ROF objects. Therefore, in some embodiments of the invention, the software architecture 20 includes a converter 30, a component that converts requests associated with the ROF object model into corresponding COM requests for the SOX component 32. Furthermore, not only does the converter 30 convert requests from one object model into requests associated with another object model, in some embodiments of the invention, the converter 30 changes a language format of the request. For example, in some embodiments of the invention, COM requests may be in an Extensible Markup Language (XML) language format, and ROF requests may be in a Teknekron Design Language (TDL) format.

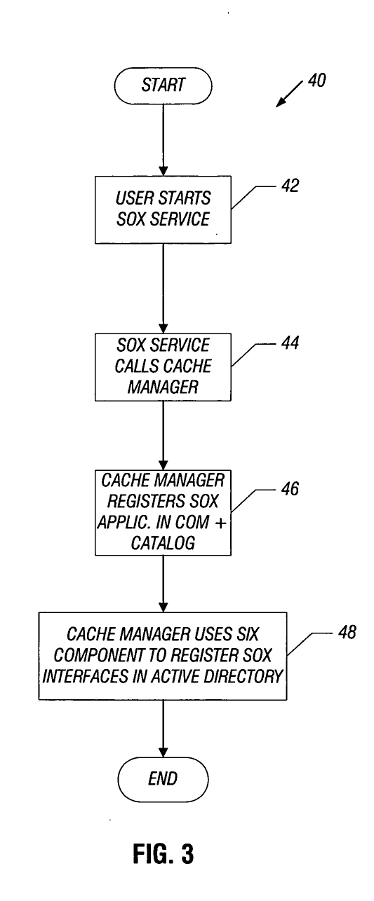

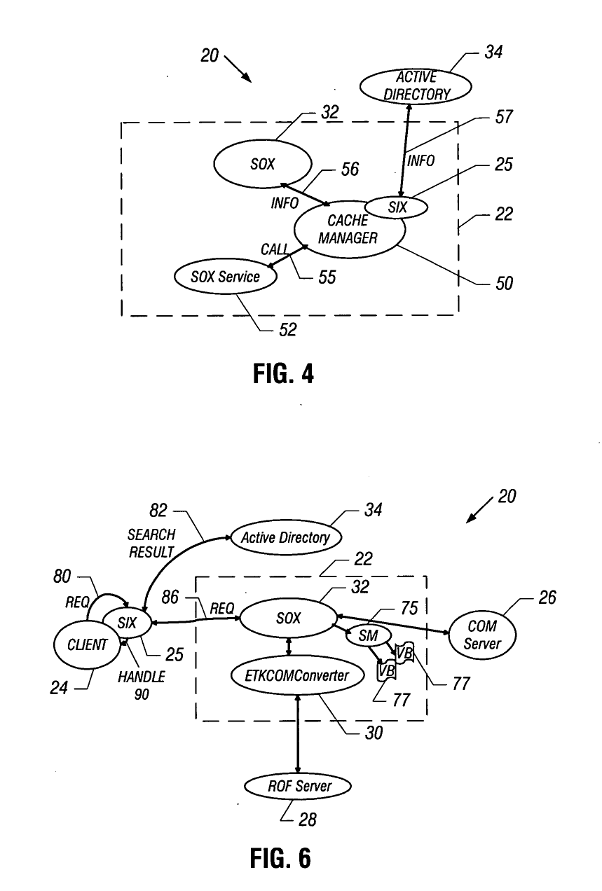

FIG. 3 generally depicts a flow diagram depicting a technique 40 to initialize the architecture 20 that is depicted in FIG. 2. The technique 40 is discussed below in connection with a more detailed selected portion of the architecture 20, depicted in FIG. 4.

Referring to FIGS. 3 and 4, pursuant to the technique 40, the initialization begins by a user starting (block 42 in FIG. 3) an instance of a SOX service 52 (FIG. 4). This instance of the SOX service 52, in turn, calls (block 44 of FIG. 3) a cache manager 50 that, in turn, registers a SOX application in a COM+ catalog. Next, the cache manager 50 uses the SIX component 25 to register (block 46) the various SOX interfaces that are created by the SOX application in the active directory 34. It is noted that the program code that forms the SOX application program may be located on one or more remote, physical servers 12 (FIG. 1).

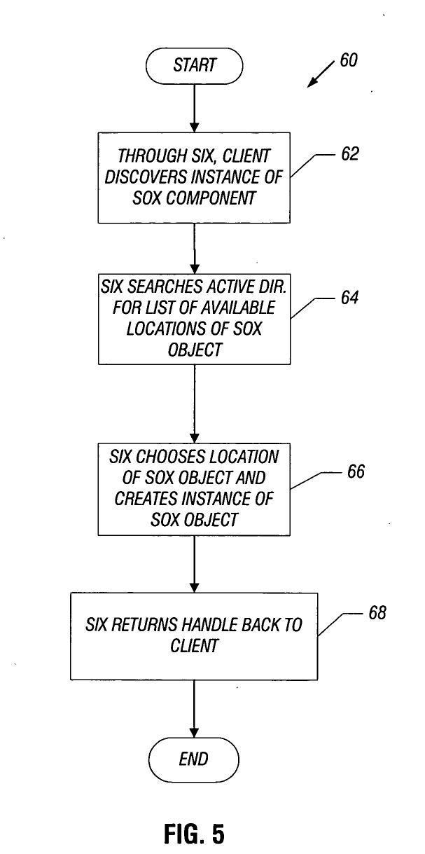

As an example, FIG. 5 is a flow diagram depicting a technique 60 for a COM client to discover an instance of the SOX component 32. The technique 60 is discussed below in connection with a more detailed selected portion of the architecture 20, depicted in FIG. 6.

In this example, the COM client 24 uses the SIX component 25 to discover (block 62 of FIG. 5) an instance of the SOX component. The SIX component 25 searches (block 64) the active directory 34 for a list of available locations for an instance of the SOX component 32. The SIX component 25, in some embodiments of the invention, chooses the location of the SOX object instance 32 and creates the SOX instance 32, as depicted in block 66 of FIG. 5. The SIX component 25 then returns (block 68) a pointer, or handle, of the instance of the SOX component 32 back to the client 24. At this point, the client 24 now has a pointer, or handle, to the instance of the SOX component 32.

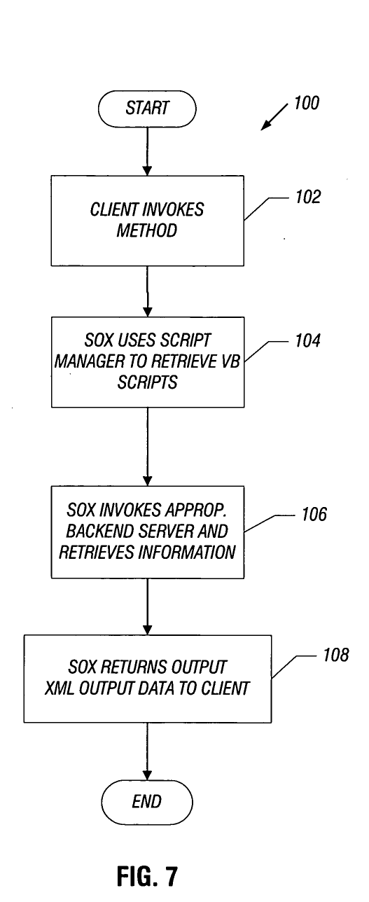

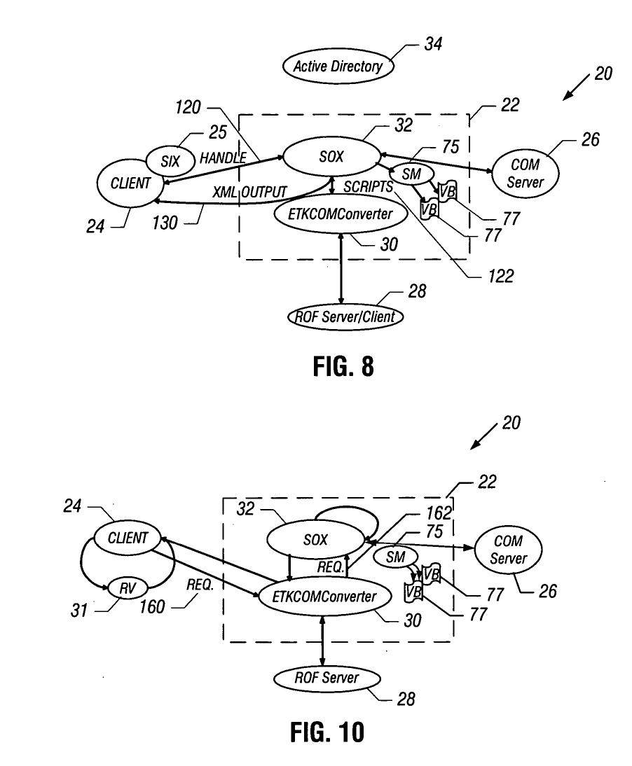

FIG. 7 is a flow diagram depicting a technique 100 for a COM client to submit a service or data request to the SOX component 32. The technique 100 is discussed below in connection with a more detailed selected portion of the architecture 20, depicted in FIG. 8.

Pursuant to the technique, the COM client 24 invokes (block 102 of FIG. 7) the required method on the SOX instance 32. Next, the SOX instance 32 uses (block 104) a script manager 75 to retrieve various scripts 77. The scripts 77, in turn, may invoke the services of COM objects or ROF objects, depending on the desired function or method to be performed. Thus, depending on the objects invoked by the execution of the scripts by the SOX instance 32, the SOX instance 32 invokes (block 106) the appropriate server 26 or 28 to retrieve the desired information. The SOX instance 32 then returns (block 108) its output to the client 24, as depicted in block 108. It is noted that in some embodiments of the invention, this output may be in an XML format.

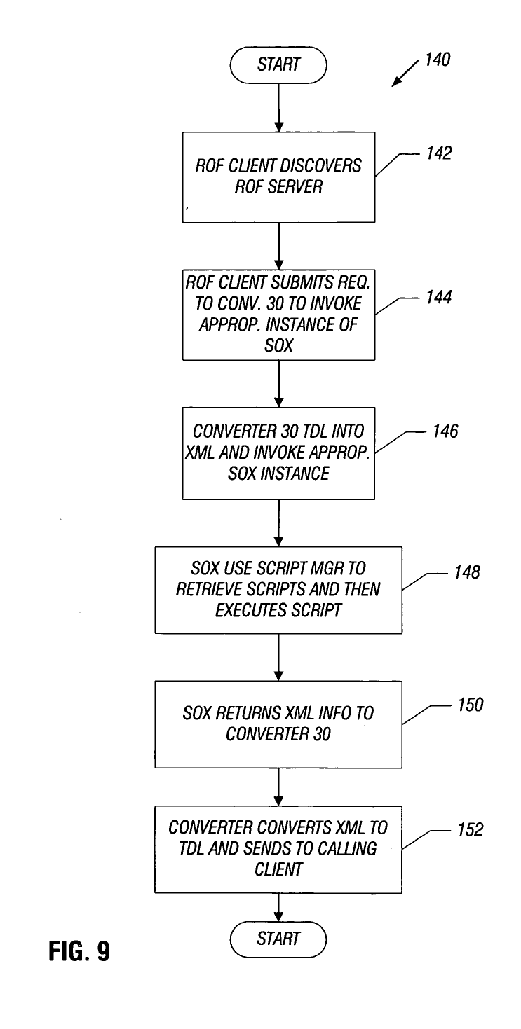

FIG. 9 is a flow diagram depicting a technique 140 for a COM client to submit a service or data request to an interface of the SOX component 32. The technique 100 is discussed below in connection with a more detailed selected portion of the architecture 20, depicted in FIG. 10.

Pursuant to the technique 140, the ROF client 24 discovers (block 142 of FIG. 9) the ROF server 28 by using, for example, a Rendezvous (RV) Daemon component 31. The RV component 31 is middleware used to listen for publish-subscribed messages. After this discovery, the ROF client 24 submits a request to the converter 30 to invoke the appropriate instance of the SOX converter 32, as depicted in block 144 of FIG. 9. The converter 30 converts the language format (a TDL format, for example) of this request into an XML format to communicate a corresponding request to invoke the appropriate SOX instance 32, as depicted in block 146. Next, the instance of the SOX component 32 uses the script manager 75 to retrieve the appropriate scripts 77; and then, the instance of the SOX component 32 executes the retrieved scripts 77 to receive information from the appropriate server 26 or 28, as depicted in block 148. As noted above, the instance of the component 32 may use information and/or invoke objects from either server 26 or 28, depending on the nature of the script 77. The instance of the SOX component 32 then returns the information (in an XML format) to the converter 30, as depicted in block 150 of FIG. 9. Lastly in the processing of this request, the converter 30 converts the XML format into a TDL format and sends the information to the ROF client 24, as depicted in block 152.

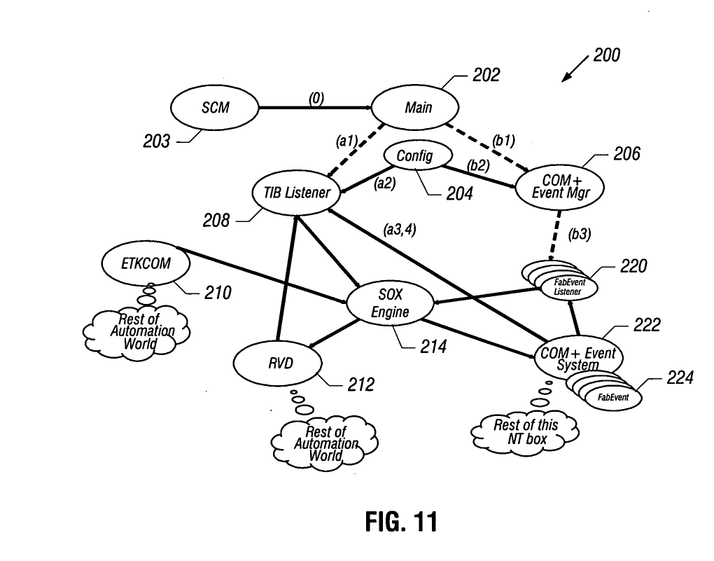

The architecture 20 described above is used for purposes of converting protocol and language formats between various software subsystems of the computing system 10. A software architecture may be also used for processing messages associated with two different types of messaging systems. For example, referring to FIG. 11, in some embodiments of the invention, the computing system 10 may use a software architecture 200 for purposes of communicating messages among different types of software subsystems.

More specifically, in some embodiments of the invention, the software architecture 200 may include a main application 202 that communicates with a security manager 203 and a TIB listener 208. The TIB listener 208 is middleware that listens for messages that are transmitted via the Rendezvous Daemon (RV) protocol. The software architecture 200 may also include a COM event manager 206 that receives notification of events from fabrication event listener components 220. A SOX engine 214 of the architecture 200 executes scripts to translate between TIB and COM messages. Furthermore, the SOX engine 214 communicates with COM event systems, such as the exemplary system 220, to handle various events. The system 220 may also receive indications of various events 224 occurring within the system 220.

In the initialization of the system 200, the main application 202 starts the TIB listener 208 that, in turn, subscribes to events that change the subscriptions of various COM objects. The TIB listener 208 also gets initial TIB subjects from a configuration file 204 and sets up the TIB subscriptions via TIB subscription elements. The TIB listener also gets the COM subscriptions and maps these COM subscriptions to TIB subjects from the configuration file 204. Next, the COM system 222 communicates new events to change subscriptions, and the TIB listener 208 changes the TIB subscriptions based on these events. Subsequently, the main application 202 starts the COM event manager 206. The COM event manager 206 then obtains a list of scripted listeners from the configuration file 204. Lastly, the COM event manager 206 sets up scripted listeners and subscribes then to specific COM events.

It is assumed herein that messages are communicated using a publish-subscribe technique in which messages are published with a subject, and subscribers to the subject receive the message. Thus, one published message may be received by several subscribers.

The software architecture 200 may operate in the following manner for purposes of converting a TIB message into a COM message. A Rendezvous Daemon (RV) message may come in from a far from the RVD component 212. In response to this RV message, the TIB listener 208 receives the message and hands off the message to the SOX engine 214. The SOX engine 214 then executes script that translates the message from a TIB format to the COM format and fires appropriate complex events. In the case of Common Information Bus Interface (CIBI) events, the converter 210 converts the associated message into an XML format and hands it off to the SOX engine 214.

Another scenario that may occur is the occurrence of a COM+ message that is associated with a COM event. Upon this occurrence, the COM event system 222 communicates this event to the listener 220. In response to the event, the listener 220 communicates the message to the SOX engine 214. Script in the SOX engine 214 then directs data translation and transmits the appropriate RV or CIBI messages.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method comprising:
providing a first request to access a function associated with a first object model;
converting the first request into a second request associated with a second object model different from the first object model; and
creating an object associated with the second object model in response to the second request.

2. The method of claim 1, further comprising:
executing a script to create the second request.

3. The method of claim 1, further comprising:
retrieving a script in response to the first request.

4. The method of claim 1, further comprising:
converting between protocols from different vendors.

5. (canceled)

6. The method of claim 1, wherein the first request is associated with fabrication of an integrated circuit.

7. The method of claim 1, further comprising:
converting between asynchronous and synchronous communication.

8. The method of claim 1, further comprising:
providing a mechanism to discover services.

9. The method of claim 1, further comprising:
distributing agents on different servers.

10. A computing system comprising:
a client to provide a first request to access a function associated with a first object model;
a first component to receive a first request to access a function associated with a first object model and convert the first request into a second request associated with a second object model different from the first object model; and
a second component to create an object associated with the second object in response to the second request.

11. The system of claim 10, wherein the first component executes at least one script to create the second request.

12. The system of claim 10, wherein the second component retrieves a script in response to the first request.

13. The system of claim 10, further comprising:
a component to convert protocols from different vendors.

14. The system of claim 10, wherein the first request is associated with fabrication of an integrated circuit.

15. The system of claim 10, further comprising:
converting between asynchronous and synchronous communication.

16. The system of claim 10, further comprising:
providing a mechanism to discover services.

17. The system of claim 10, further comprising:
distributing agents on different servers.

18. An article comprising a storage medium storing instructions that when executed cause a processor-based system to:
provide a first request to access a function associated with a first object model;
convert the first request into a second request associated with a second object model different from the first object model; and
create an object associated with the second object model in response to the second request.

19. The article of claim 18, further comprising instructions to cause the processor-based system to:
execute a script to create the second request.

20. The article of claim 18, further comprising to cause the processor-based system to:
retrieve a script in response to the first request.

21. The article of claim 18, storing instructions to cause the processor-based system to convert protocols between different vendors.

22. The article of claim 18, wherein the first request is associated with fabrication of an integrated circuit.

23. The article of claim 18, further comprising:
converting between asynchronous and synchronous communication.

24. The article of claim 18, further comprising:
providing a mechanism to discover services.

25. The article of claim 18, further comprising:
distributing agents on different servers.

26. A method comprising:
using a subscriber to a publish-subscribe messaging protocol to receiving a message published via the protocol; and
communicating the message to multiple non-subscribers.

27. The method of claim 26, wherein the non-subscribers comprise COM clients.

28. The method of claim 26, wherein the communicating comprises:
generating multiple messages to the non-subscribers.

29. The method of claim 26, further comprising:
converting the received message from a first language format into a second language format,
wherein the communicating the message comprises communicating the message in the second language format.

30. A system comprising:
a first component to subscribe to a publish-subscribe messaging protocol to receive a message published via the protocol; and
a second component to communicate the message to multiple non-subscribers to the protocol.

31. The system of claim 30, wherein the non-subscribers comprise COM clients.

32. The system of claim 30, wherein the second component generates multiple messages to the non-subscribers.

33. The system of claim 30, wherein the second component coverts the received message from a first language format into a second language format and communicates the message to multiple non-subscribers in the second language format.

34. An article comprising a storage medium storing instructions to cause a processor-based system to:
use a subscriber to a publish-subscribe messaging protocol to receive a message published via the protocol; and
communicate the message to multiple non-subscribers of the protocol.

35. The article of claim 34, wherein the non-subscribers comprise COM clients.

36. The article of claim 34,further comprising instructions to cause the processor-based system to:
generate multiple messages to the non-subscribers.

37. The article of claim 34, further comprising to cause the processor-based system to:
convert the received message from a first language format into a second language format, and
communicate the message in the second language format.
